(19) United States
(12) Patent Application Publication
(10) Pub. No.: US 2026/0082246 A1
(43) Pub. Date: Mar. 19, 2026

(54) PEER-TO-PEER SCHEDULING OF NETWORK SERVICE ACTIVITIES

(71) Applicant: T-Mobile USA, Inc., Bellevue, WA (US)

(72) Inventors: Emile Minh Tran, Sammamish, WA (US); Antoine T. Tran, Bellevue, WA (US); Robert Andrew Berrier, Renton, WA (US); Luis Alberto Uribe Gonzalez, Parsippany, NJ (US); Venu GR Mudunuri, Carrollton, TX (US); Justin R. Mueller, Sammamish, WA (US)

(21) Appl. No.: 18/887,021

(22) Filed: Sep. 16, 2024

(51) Int. Cl. H04W 24/04

(52) U.S. Cl. CPC H04W 24/04

(57) ABSTRACT

When a set of neighbor radio sites requires that a network service activity (e.g., upgrade) be performed, each radio site determines (a) whether it needs the activity (i.e., it has not yet been performed), (b) whether it is in process of the activity being performed, or (c) what its expected traffic will be for however long the activity requires. Radio sites that still need the activity bid values that are inversely proportional to the expected traffic so the lower their traffic the more likely they are to win, radio sites that do not need the activity bid a number that ensures they lose, and radio sites that are still in process (if any) bid a number that ensures they will win, so that 2 neighbor sites are not unavailable at the same time. This automatically selects the radio site having the lowest traffic for the activity in a peer-to-peer manner.

### BACKGROUND

Modern cellular networks typically require network service activities relatively often, such as upgrades (software and hardware), maintenance, and configuration changes, including frequency retuning when new spectrum becomes available. Even relatively quick network service activities may take a base station at a radio site (e.g., a cell site or cell cluster) offline for 10 to 30 minutes, during which time the radio site is unable to provide service to user equipment (UEs) in the vicinity. When a network service activity is performed on all or most radio sites in some market (e.g., the cellular coverage for a metropolitan area) UEs may find themselves in the middle of a “dead zone”, entirely without service, for the duration of a network service activity. This adversely affects usability and service reliability for large numbers of UEs.

### SUMMARY

The following summary is provided to illustrate examples disclosed herein, but is not meant to limit all examples to any particular configuration or sequence of operations.

Solutions are disclosed that perform peer-to-peer scheduling of network service activities in a manner that minimizes service disruptions in a wireless network. Examples receive, by a first radio site of a set of radio sites, an indication that a network service activity is to be performed, wherein the set of radio sites comprises neighbor radio sites each having coverage zones overlapping with or adjacent to a coverage zone of another radio site of the set of radio sites; generate, by each radio site of the set of radio sites, an activity bid, wherein the activity bid is selected from the list of bids consisting of: a numerical value between a minimum value and a maximum value, a no activity bid having a numerical value below the minimum value, and a busy bid having a numerical value above the maximum value; select, from the set of radio sites, a radio site having a highest activity bid for performing the network service activity; and either: based on at least the selected radio site not having the busy bid, perform the network service activity for the selected radio site; or based on at least the selected radio site having the busy bid, complete the network service activity for the selected radio site.

### BRIEF DESCRIPTION OF THE DRAWINGS

The disclosed examples are described below with reference to the accompanying drawing figures listed below, wherein:

FIG. 1 illustrates an exemplary architecture that advantageously orchestrate network service activities using predicted traffic in order to minimize service disruptions;

FIG. 2 illustrates a plurality of radio sites (e.g., cells or cell clusters), as may exist in examples of the architecture of FIG. 1;

FIG. 3 illustrates examples of neighbor cells, as may occur in examples of the plurality of radio sites of FIG. 2;

FIG. 4 illustrates an exemplary plurality of radio sites for which a network service activity is required for at least one of the radio sites, as may occur in examples of the architecture of FIG. 1;

FIG. 5 illustrates network traffic prediction parameters, as may be used in examples of the architecture of FIG. 1;

FIG. 6 illustrates further detail of an exemplary peer-to-peer selection arrangement, as may occur in examples of the architecture of FIG. 1;

FIG. 7 illustrates exemplary details of peer-to-peer bidding, as may be used in the peer-to-peer selection arrangement of FIG. 6;

FIG. 8 illustrates exemplary details of selecting a bidding of the peer-to-peer bidding arrangement of FIG. 7;

FIG. 9 illustrates an exemplary timeline of performing the network service activity in examples of the architecture of FIG. 1;

FIGS. 10 and 11 illustrate flowcharts of exemplary operations associated with the architecture of FIG. 1; and

FIG. 12 illustrates a block diagram of a computing device suitable for implementing various aspects of the disclosure.

Corresponding reference characters indicate corresponding parts throughout the drawings, where practical. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

Solutions are disclosed that perform peer-to-peer scheduling of network service activities in a manner that minimizes service disruptions in a wireless network. When a set of neighbor radio sites requires that a network service activity (e.g., upgrade, frequency retuning, etc.) be performed, each radio site determines (a) whether it needs the activity (i.e., it has not yet been performed), (b) whether it is in process of the activity being performed, or (c) what its expected traffic will be for however long the activity will require. Radio sites that still need the activity bid a value that is inversely proportional to the expected traffic so the lower their traffic the more likely they are to win, radio sites that do not need the activity bid a number that ensures they lose, and radio sites that are still in process (if any) bid a number that ensures they will win, so that 2 neighbor sites are not unavailable at the same time. This minimizes service disruptions in which user equipment (UE) are left entirely without service for the duration of the network service activity by automatically selecting the radio site having the lowest traffic for the activity in a peer-to-peer manner, without requiring an external (centralized) orchestrator.

Aspects of the disclosure thus improve the performance of wireless (cellular) networks by preventing neighbor radio sites (cells or cell clusters) from becoming unavailable at the same time, thus avoiding scenarios in which UEs are unable to receive service from any radio site the duration of the network service activity. This reduces negative impacts on a large number of network users. These advantageous results are accomplished, at least in part, by selecting, from the set of radio sites, a radio site having a highest activity bid for performing the network service activity.

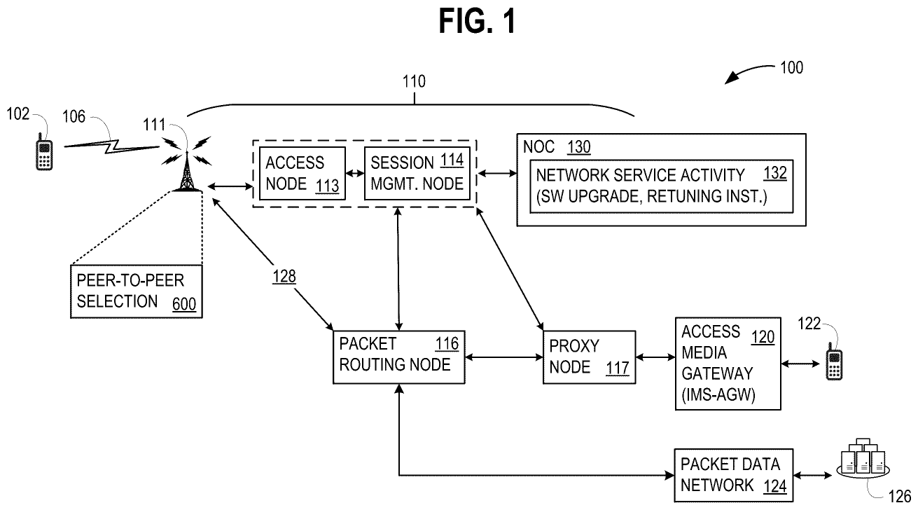

With reference now to the figures, FIG. 1 illustrates an exemplary architecture 100 that advantageously perform peer-to-peer scheduling of network service activities in a manner that minimizes service disruptions. A wireless network 110 is illustrated that is serving a UE 102. UE 102 may be an enhanced Mobile Broadband (eMBB) or cellphone, a fixed wireless access (FWA), internet of things (IoT) device, machine-to-machine (M2M) communication device, a personal computer (PC, e.g., desktop, notebook, tablet, etc.) with a cellular modem, or another telecommunication devices capable of using a wireless network. In the scene depicted in FIG. 1, UE 102 is using wireless network 110 for a packet data session to reach a network resource 126 (e.g., a website) across an external packet data network 124 (e.g., the internet). In some scenarios, UE 102 may use wireless network 110 for a phone call with another UE 122. Wireless network 110 may be a cellular network such as a fifth generation (5G) network, a fourth generation (4G) network, or another cellular generation network. In some contexts, 5G is also referred to as new radio (NR), and standalone 5G, which is a full 5G implementation that does not rely on 4G technology for some functionality, may be referred to SA NR.

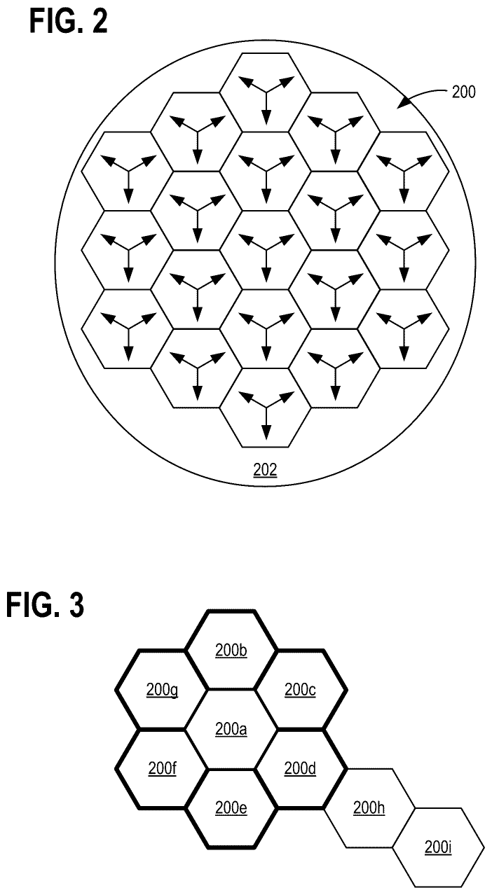

UE 102 uses an air interface 106 to communicate with a base station 111 of wireless network 110, such that base station 111 is the serving base station for UE 102 (providing the serving cell). In some scenarios, base station 111 may be referred to as a radio access network (RAN), and is located at a radio site (See FIG. 2). Wireless network 110 has an access node 113, a session management node 114, and other components (not shown). Wireless network 110 also has a packet routing node 116 and a proxy node 117. Access node 113 and session management node 114 are within a control plane of wireless network 110, and packet routing node 116 is within a data plane (a.k.a. user plane) of wireless network 110.

Base station 111 is in communication with access node 113 and packet routing node 116. Access node 113 is in communication with session management node 114, which is in communication with packet routing node 116 and proxy node 117. Packet routing node 116 is in communication with proxy node 117 and packet data network 124. In some 5G examples, base station 111 comprises a gNodeB (gNB), access node 113 comprises an access mobility function (AMF), session management node 114 comprises a session management function (SMF), and packet routing node 116 comprises a user plane function (UPF).

In some 4G examples, base station 111 comprises an eNodeB (eNB), access node 113 comprises a mobility management entity (MME), session management node 114 comprises a system architecture evolution gateway (SAEGW) control plane (SAEGW-C), and packet routing node 116 comprises an SAEGW-user plane (SAEGW-U). In some examples, proxy node 117 comprises a proxy call session control function (P-CSCF) in both 4G and 5G.

In some examples, wireless network 110 has multiple ones of each of the components illustrated, in addition to other components and other connectivity among the illustrated components. In some examples, wireless network 110 has components of multiple cellular technologies operating in parallel in order to provide service to UEs of different cellular generations. For example, wireless network 110 may use both a gNB and an eNB co-located at a common cell site. In some examples, multiple cells may be co-located at a common cell site, and may be a mix of 5G and 4G.

Proxy node 117 is in communication with an internet protocol (IP) multimedia system (IMS) access gateway (IMS-AGW) 120 within an IMS, in order to provide connectivity to other wireless (cellular) networks, such as for a call with a UE 122 or a public switched telephone system (PSTN, also known as plain old telephone system, POTS). In some examples, proxy node 117 may be considered to be within the IMS. UE 102 reaches network resource 126 using packet data network 124 (or the IMS, in some examples). Data packets of data traffic 128 to/from UE 102 pass through at least base station 111 and packet routing node 116 on their way from/to packet data network 124 or IMS-AGW 120 (via proxy node 117).

As described more fully below, in relation to the other figures, peer-to-peer selection logic 600 at each radio site (e.g., in base station 111) schedules a network service activity 132 for nodes of wireless network 110. Network service activity 132 may be an intangible abstraction in some examples (such as an activity of replacing equipment), but is represented in FIG. 1 as a tangible item such as a software upgrade package or frequency retuning instructions. Wireless network 110 has a network operations center 130 that may be involved in administering network service activity 132.

Although FIG. 1 and some of the following figures are described using an example of a cellular network, it should be understood that the teachings herein are applicable to other types of wireless networks. To benefit from the teachings herein, another type of wireless network should offer geographically-dispersed radio sites with overlapping and/or adjacent coverage, such that a UE being served by one radio site may move over to being served by a neighboring radio site when the initially-serving radio site goes offline for a network service activity. With such a configuration, the teachings herein may extend to the other types of wireless network.

FIG. 2 illustrates a plurality of radio sites 200 in a geographic region 202. Plurality of radio sites 200 are the UE-facing portion of wireless network 110 within geographic region 202, and each radio site of plurality of radio sites 200 may contain one or more of base station 111. Performance of network service activity 132 may be limited to radio sites only within a single geographic region (or market, such as a metropolitan area) and/or under the control of one of possible multiple network managers within the geographic region at a time, in some scenarios.

FIG. 3 illustrates a definition of tier 1 neighbors, using radio sites 200a-200i of radio sites 200. A central radio site 200a is surrounded by its tier 1 neighbors: a radio site 200b, a radio site 200c, a radio site 200d, a radio site 200e, a radio site 200f, and a radio site 200g—each of which is immediately adjacent to radio site 200a and thus has an adjacent coverage zone. Because radio sites 200b-200g are tier 1 neighbors of radio site 200a, a UE that is being served by radio site 200a may also have sufficient radio channel quality with one (or more) of radio sites 200b-200g to be served by that radio site when radio site 200a goes offline for network service activity 132. This is an overlapping coverage scenario. A supercell that has a coverage area overlapping with the coverage area of radio site 200a is another overlapping coverage scenario.

It is desirable that, when radio site 200a is scheduled for performance of network service activity 132, none of radio sites 200b-200g are also scheduled to begin performance of network service activity 132. Instead, performance of performance of network service activity 132 on one or more of radio sites 200b-200g should be contingent on completion of network service activity 132 on radio site 200a, and radio site 200a returning to servicing UEs. To provide a contrast to clarify the definition of tier 1 neighbor, a radio site 200h and a radio site 200i are not tier 1 neighbors of radio site 200a—although they are tier 1 neighbors of each other. Thus, it is likely acceptable for radio site 200h or radio site 200i (but not both) to be scheduled for performance of network service activity 132 simultaneously with radio site 200a.

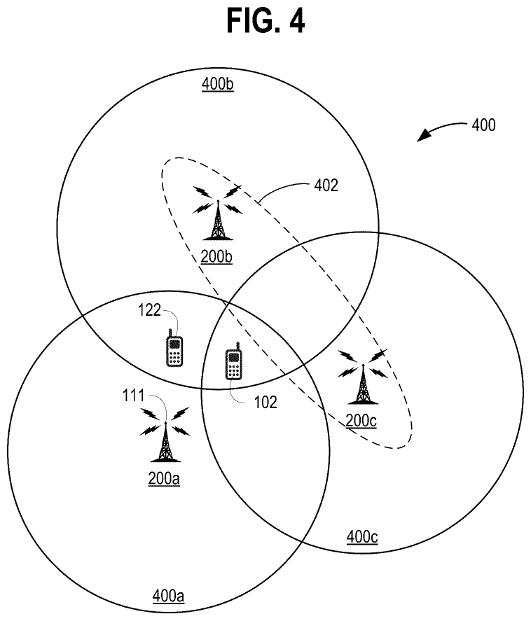

FIG. 4 illustrates an exemplary set of radio sites 400 that are all neighbor radio sites. That is radio sites 200b and 200c are neighbor radio sites 402 of radio site 200a. Radio site 200a has a coverage zone 400a, radio site 200b has a coverage zone 400b, and radio site 200c has a coverage zone 400c. As illustrated, coverage zones 400a, 400b, and 400c are both adjacent and overlap, at least to some extent. UE 102 is being served by base station 111 of radio site 200a. If radio site 200a becomes unavailable because network service activity 132 is being performed on base station 111 (i.e., being performed on radio site 200a), UE 102 is able to use either radio site 200b or radio site 200c.

In this illustrated scenario, UE 122 is being served by radio site 200b, and does not have coverage available from radio site 200c. If radio site 200b becomes unavailable while network service activity 132 is being performed on radio site 200a, UE 122 will lose coverage, disrupting network traffic. Thus, as explained below, peer-to-per selection logic 600 will not schedule radio site 200b for network service activity 132 until network service activity 132 is completed for radio site 200a. At that point, if radio site 200b becomes unavailable while network service activity 132 is being performed, UE 122 will be able to use radio site 200a.

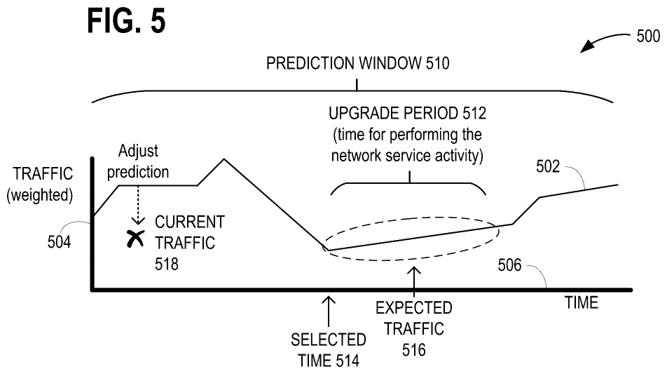

FIG. 5 illustrates a traffic prediction 500 that is performed by peer-to-per selection logic 600 of each radio site of set of radio sites 400 for which network service activity 132 is still needed, and which will submit an activity bid to bid on performing network service activity 132 (i.e., not a busy bid or a no-activity bid). For illustration purposes, traffic 502 is shown in FIG. 5 plotted as a weighted traffic value 504 as a function of time 506, although actual examples of architecture 100 may instead merely determine traffic 502 as a vector of values. Traffic 502 may be weighted such that traffic for an FWA device is weighted differently than traffic for an eMBB device, traffic for an eMBB device having WiFi and/or WiFi calling available is weighted differently than traffic for an eMBB device not having WiFi access, and/or traffic for a UE having a prioritized network slice is weighted differently than traffic for a UE not having a prioritized network slice.

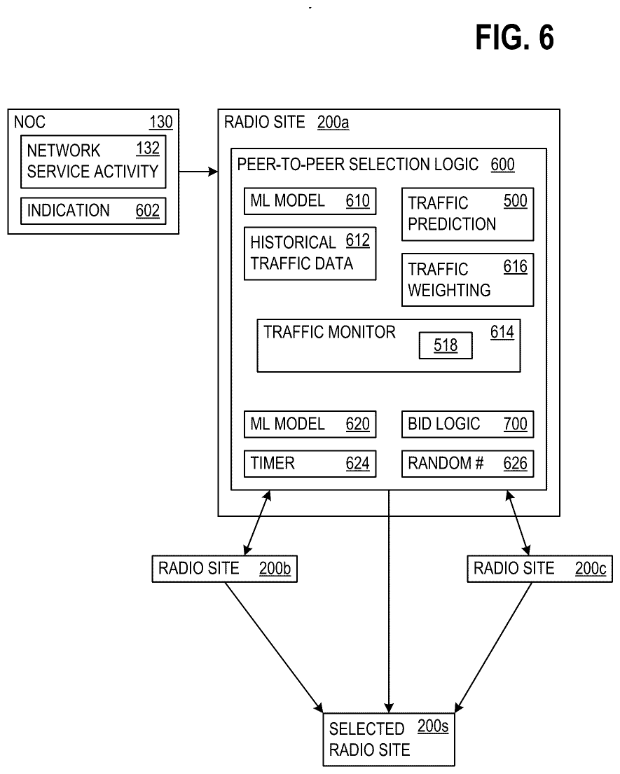

Traffic 502 is predicted for at least the duration of a prediction window 510, which may be 20 or 30 minutes, up to in duration, using historical traffic information (as explained in further detail in relation to FIG. 6). In some examples, prediction window 510 is approximately the same length as an upgrade period 512, which is the time that is required for performing network service activity 132, and may be 20 or 30 minutes, up to two hours. In some examples, prediction window 510 is longer than upgrade period 512 by an hour or more, and a delayed selected time 514 is selected (i.e., a delayed start time), for which expected traffic 516 for the duration of upgrade period 512 is the lowest.

In some examples, the current traffic 518 of each radio site is used to adjust the traffic predictions 500 for that radio site, in case one radio site happens to have unexpectedly low or high traffic at the time. This approach automatically takes into account differences between industrial, commercial, and residential areas, in which some have heavy daytime traffic (people are at work), but lesser evening and night time traffic (people go home), whereas others may have lesser daytime traffic and greater evening traffic (people come home from work and then go to sleep).

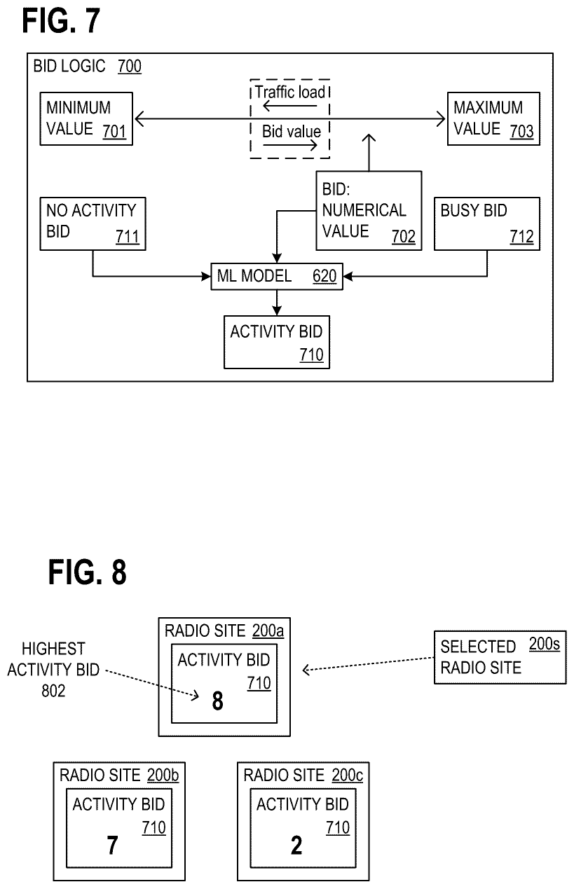

FIG. 6 illustrates further detail for peer-to-peer selection logic 600. Network operations center 130 sends an indication 602 to radio site 200a that network service activity 132 is needed. Radio site 200a has peer-to-peer selection logic 600, which is uses to communicate with radio sites 200b and 200c to select, among themselves in a peer-to-peer fashion, which one of radio sites 200a-200c is selected radio site 200s, and will have network service activity 132 performed first (or next, in one has already completed or is in process with network service activity 132). Radio sites 200b and 200c each have their own peer-to-peer selection logic 600. Selected radio site 200s may be any of radio sites 200a, 200b, or 200c, based on their respective activity bids, as described later, in relation to FIG. 7.

Peer-to-peer selection logic 600 has a machine learning (ML) model 610 that generates traffic prediction 500 for radio site 200a using historical traffic data 612. ML is used herein interchangeably with artificial intelligence (AI). In some examples, traffic prediction 500 is weighted according to traffic weighting 616 (as described above, in relation to FIG. 5, for weighting of traffic 502). A traffic monitor 614 determines current traffic 518.

A bid logic 700, which is shown in further detail in FIG. 7, expected traffic 516, and in some examples, uses an ML model 620 to determine a bid. The highest bid from among radio sites 200a-200c wins. If radio site 200a does not win, it sets a timer 624, for example for one hour, along with other non-winning radio sites, and at the expiration of timer 624, the radio sites bid again. In the event of a tie between two or more radio sites, a random number 626 is generated by the peer-to-peer selection logic 600 in each of the tied radio sites, and that random number (e.g., the highest value) is used as a tie-breaker to declare the winner.

An example of multiple rounds of bidding, in which each of radio sites 200a-200c takes its turn as selected radio site 200s (i.e., the winner), and has network service activity 132 performed, is described at the end of the description of FIG. 8, below.

FIG. 7 illustrates further detail for bid logic 700, and how it generates an activity bid 710. In general, the higher the traffic load (based on expected traffic 516), the lower a radio site will bid, and the lower the traffic load, the higher the radio site will bid. This scheme favors the radio site with the least expected traffic to go first (or next). A regular bid's numerical value 702 is between a minimum value 701, at the low end, and a maximum value 703, at the upper end. In some examples, minimum value 701 is 0 (zero), and maximum value 703 is 10 (ten).

A no activity bid 711, which may be −1 (negative one) in some examples, is used when a radio site has already completed network service activity 132, so that it will not win the bid. A no activity bid 711 may also be used when a radio site is excluded from network service activity 132 for any other reason (e.g., equipment incompatibility, such as lacking minimum requirements, or alternative plans for the radio site). When all radio sites in set of radio sites 400 bid no activity bid 711, the bidding ends, because no more radio sites need network service activity 132 to be performed. A busy bid 712, which may be 100 (one hundred) in some examples, is used when a radio site is still in the process of network service activity 132 being performed, so that it will win the bid. This prevents two radio sites within set of radio sites 400 from being taken offline at the same time for network service activity 132. ML model 620 (or other logic) selects activity bid 710 from among numerical value 702, no activity bid 711, and busy bid 712, and peer-to-peer selection logic 600 shares activity bid 710 for its radio site with the peer-to-peer selection logic 600 in each of the other radio sites within set of radio sites 400.

FIG. 8 illustrates an example bidding round. Radio site 200a generates its activity bid 710 as a value of 8 (eight), radio site 200b generates its activity bid 710 as a value of 7 (seven), and radio site 200c generates its activity bid 710 as a value of 2 (two). Activity bid 710 of radio site 200b is the highest activity bid 802, and so for this round of bidding, radio site 200b wins and becomes selected radio site 200s. Radio site 200a starts network service activity 132, and each of radio sites 200b and 200c set their timer 624 (e.g., for one hour).

At the expiration of timer 624, each of radio sites 200b and 200c generate new activity bids 710, each between minimum value 701 and maximum value 703. However, in this instant example, radio site 200a has not yet completed network service activity 132, and so radio site 200a generates a new activity bid 710 with a value of busy bid 712 (e.g., 100). Radio site 200a wins this second round of bidding also, preventing either of radio sites 200b and 200c from starting network service activity 132. Radio site 200a continues network service activity 132, and each of radio sites 200b and 200c again set their timer.

At the next expiration of timer 624, each of radio sites 200b and 200c generate new activity bids 710, each between minimum value 701 and maximum value 703. However, because radio site 200a has now completed network service activity 132, and radio site 200a generates a new activity bid 710 with a value of no activity bid 711 (e.g., −1) and so cannot win. However, in this instant example, radio sites 200b and 200c are tied. So each of radio sites 200b and 200c generates their own random number 626, and in this example, radio site 200b wins the tie-breaker. Radio site 200b is now selected radio site 200s (i.e., newly selected radio site 200n) and starts network service activity 132, and at least radio site 200c sets its timer 624. In some examples, all losing radio sites set their timer 624, whereas in some examples, only losing radio rites that still require network service activity 132 set their timer 624.

At the next expiration of timer 624, radio sites 200c generates a new activity bid 710, between minimum value 701 and maximum value 703. However, because radio sites 200a and 200b have each now completed network service activity 132, radio sites 200a and 200b each generates a new activity bid 710 with a value of no activity bid 711, and cannot win. Radio site 200c is the winner and is now selected radio site 200s (i.e., newly selected radio site 200n). Radio site 200c starts network service activity 132.

In examples for which all non-winning radio sites set their timer 624 (even if they have already completed network service activity 132), at the expiration of timer 624, all of radio sites 200a-200c generates a new activity bid 710 with a value of no activity bid 711. No radio sites are declared winners, and bidding ceases, because all radio sites of set of radio sites 400 have completed network service activity 132.

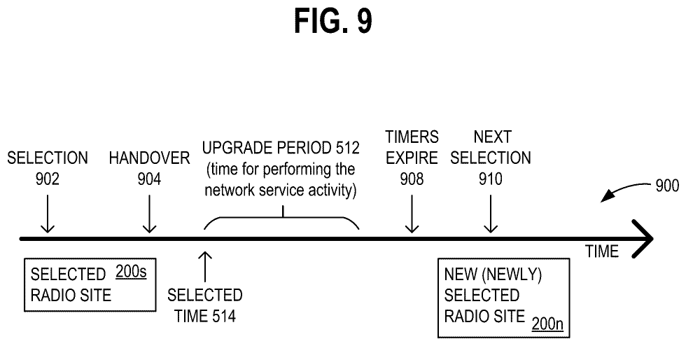

FIG. 9 illustrates an exemplary timeline 900 of performing network service activity 132. The selection of selected radio site 200s is performed at a selection event 902. Prior to taking selected radio site 200s offline to perform network service activity 132, a handover 904 is triggered for each UE currently using selected radio site 200s, and which has an alternate traffic solution available (e.g., another radio site or moving to WiFi, including WiFi calling). At selected time 514, network service activity 132 is started for selected radio site 200s. This lasts for the duration of upgrade period 512, which is the time for performing the network service activity 132.

Any timers, used for delaying the start of the next radio site selection process, expire at expiration event 908, and a new radio site 200n (or newly selected radio site 200n) is selected from among set of radio sites 400 at a selection event 910. New radio site 200n may be any of the radio sites remaining of radio sites 200a-200c. This continues until there are no radio sites remaining within set of radio sites 400, because network service activity 132 has been performed for all radio sites of the original set of radio sites 400.

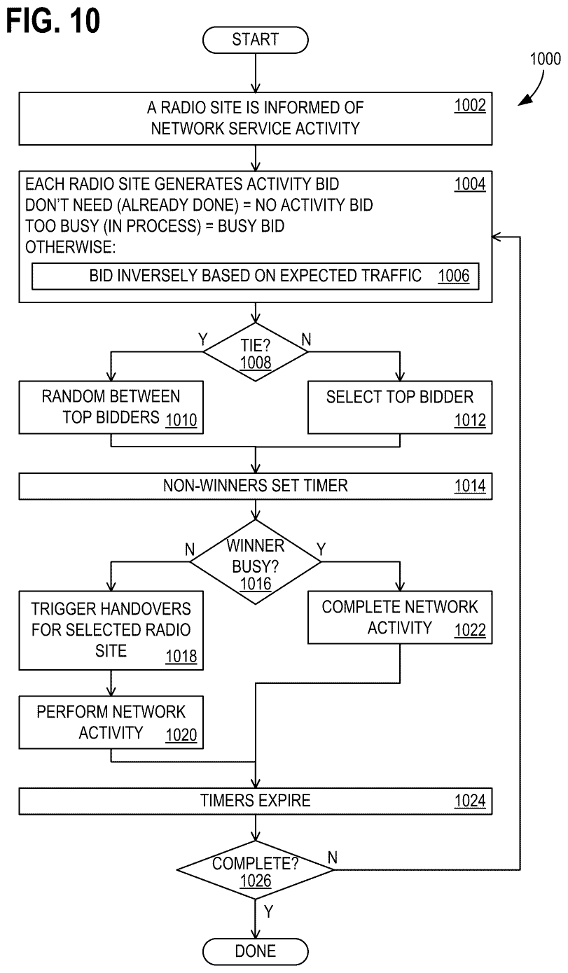

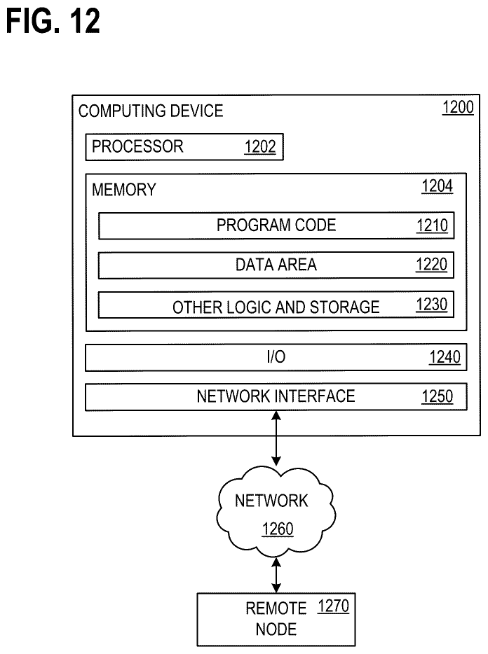

FIG. 10 illustrates a flowchart 1000 of exemplary operations associated with architecture 100. In some examples, at least a portion of flowchart 1000 may be performed using one or more computing devices 1200 of FIG. 12. Flowchart 1000 commences with radio site 200a receiving indication 602 that network service activity 132 is to be performed, in operation 1002. Network service activity 132 may be any of: frequency retuning, a software upgrade, maintenance, and a hardware upgrade. Radio site 200a is part of set of radio sites 400 that comprises neighbor radio sites each having coverage zones 400a-400c overlapping with or adjacent to a coverage zone of another radio site of set of radio sites 400.

In operation 1004, each radio site of set of radio sites 400 generates its activity bid 710, which is selected from a numerical value 702 between minimum value 701 and maximum value 703, no activity bid 711 having a numerical value below minimum value 701, and busy bid 712 having a numerical value above maximum value 703. A radio site that has already upgraded submits no activity bid 711, and a radio site that is currently undergoing network service activity 132 submits busy bid 712. Operation 1004 includes operation 1006, in which each radio site not submitting no activity bid 711 or busy bid 712 determines numerical value 702 as inversely related to expected traffic 516 for the radio site for upgrade period 512. In some examples, ML determines expected traffic 516 using historical traffic data 612, and in some examples, expected traffic 516 is weighted by traffic type and/or UE type.

Decision operation 1008 determines whether the highest bidders are tied. If so, based on at least two or more radio sites submitting equal numerical values, operation 1010 selects from among the two or more radio sites randomly. Otherwise, absent a tie, operation 1012 selects, from among set of radio sites 400, selected radio site 200s having highest activity bid 802 for performing network service activity 132. Selecting selected radio site 200s is performed as a peer-to-peer decision, without involving an orchestrator outside set of radio sites 400.

In operation 1014, each radio site of set of radio sites 400 (still requiring network service activity 132), except selected radio site 200s, sets its timer 624. Decision operation 1016 determines whether selected radio site 200s submitted busy bid 712. If not, then prior to performing network service activity 132, operation 1018 triggers handover 704 for each UE being served by selected radio site 200s and having available coverage from another radio site. Network service activity 132 is performed for selected radio site 200s as operation 1020. If, however, selected radio site 200s did submitted busy bid 712, network service activity 132 is completed for selected radio site 200s as operation 1022.

Timer(s) 624 expire in operation 1024, and decision operation 1026 determines whether any radio site still requires network service activity 132. If not, flowchart 1000 terminates. However, if any radio site still requires network service activity 132 flowchart 1000 returns to operation 1024 upon expiration of timer 624. Moving through flowchart 1000 again, in an iterative manner, results in generating new activity bids, and using the new activity bids to select new radio site 200n from set of radio sites 400 for performing network service activity 132 until no radio sites remain that still require network service activity 132.

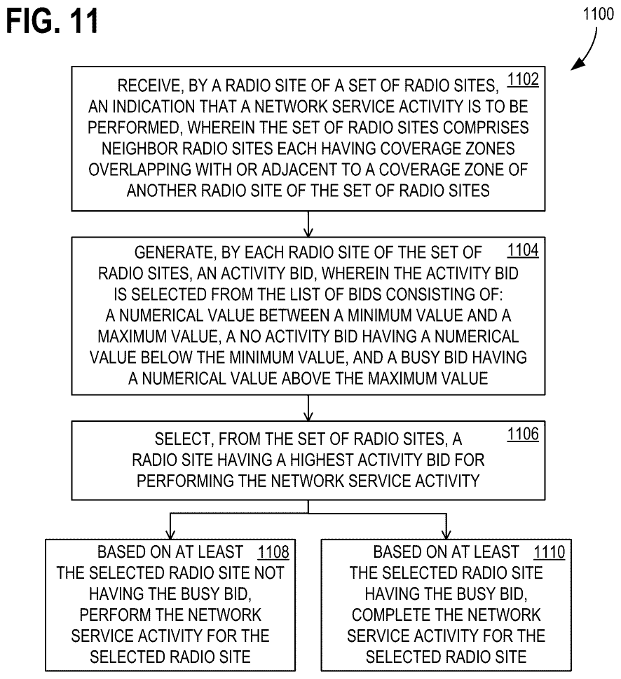

FIG. 11 illustrates a flowchart 1100 of exemplary operations associated with examples of architecture 100. In some examples, at least a portion of flowchart 1100 may be performed using one or more computing devices 1200 of FIG. 12. Flowchart 1100 commences with operation 1102, which includes receiving, by a first radio site of a set of radio sites, an indication that a network service activity is to be performed, wherein the set of radio sites comprises neighbor radio sites each having coverage zones overlapping with or adjacent to a coverage zone of another radio site of the set of radio sites.

Operation 1104 includes generating, by each radio site of the set of radio sites, an activity bid, wherein the activity bid is selected from the list of bids consisting of: a numerical value between a minimum value and a maximum value, a no activity bid having a numerical value below the minimum value, and a busy bid having a numerical value above the maximum value. Operation 1106 includes selecting, from the set of radio sites, a radio site having a highest activity bid for performing the network service activity.

Then, either operation 1108 is performed, or operation 1110 is performed. Operation 1108 includes, based on at least the selected radio site not having the busy bid, performing the network service activity for the selected radio site. Operation 1110 includes, based on at least the selected radio site having the busy bid, completing the network service activity for the selected radio site.

FIG. 12 illustrates a block diagram of computing device 1200 that may be used as any component described herein that may require computational or storage capacity. Computing device 1200 has at least a processor 1202 and a memory 1204 that holds program code 1210, data area 1220, and other logic and storage 1230. Memory 1204 is any device allowing information, such as computer executable instructions and/or other data, to be stored and retrieved. For example, memory 1204 may include one or more random access memory (RAM) modules, flash memory modules, hard disks, solid-state disks, persistent memory devices, and/or optical disks. Program code 1210 comprises computer executable instructions and computer executable components including instructions used to perform operations described herein. Data area 1220 holds data used to perform operations described herein. Memory 1204 also includes other logic and storage 1230 that performs or facilitates other functions disclosed herein or otherwise required of computing device 1200. An input/output (I/O) component 1240 facilitates receiving input from users and other devices and generating displays for users and outputs for other devices. A network interface 1250 permits communication over external computer network 1260 with a remote node 1270, which may represent another implementation of computing device 1200. For example, a remote node 1270 may represent another of the above-noted nodes within architecture 100.

### Additional Examples

An example system comprises: a processor; and a computer-readable medium storing instructions that are operative upon execution by the processor to: receive, by a first radio site of a set of radio sites, an indication that a network service activity is to be performed, wherein the set of radio sites comprises neighbor radio sites each having coverage zones overlapping with or adjacent to a coverage zone of another radio site of the set of radio sites; generate, by each radio site of the set of radio sites, an activity bid, wherein the activity bid is selected from the list of bids consisting of: a numerical value between a minimum value and a maximum value, a no activity bid having a numerical value below the minimum value, and a busy bid having a numerical value above the maximum value; select, from the set of radio sites, a radio site having a highest activity bid for performing the network service activity; and either: based on at least the selected radio site not having the busy bid, perform the network service activity for the selected radio site; or based on at least the selected radio site having the busy bid, complete the network service activity for the selected radio site.

An example method comprises: receiving, by a first radio site of a set of radio sites, an indication that a network service activity is to be performed, wherein the set of radio sites comprises neighbor radio sites each having coverage zones overlapping with or adjacent to a coverage zone of another radio site of the set of radio sites; generating, by each radio site of the set of radio sites, an activity bid, wherein the activity bid is selected from the list of bids consisting of: a numerical value between a minimum value and a maximum value, a no activity bid having a numerical value below the minimum value, and a busy bid having a numerical value above the maximum value; selecting, from the set of radio sites, a radio site having a highest activity bid for performing the network service activity; and either: based on at least the selected radio site not having the busy bid, performing the network service activity for the selected radio site; or based on at least the selected radio site having the busy bid, completing the network service activity for the selected radio site.

One or more example computer storage devices has computer-executable instructions stored thereon, which, upon execution by a computer, cause the computer to perform operations comprising: receiving, by a first radio site of a set of radio sites, an indication that a network service activity is to be performed, wherein the set of radio sites comprises neighbor radio sites each having coverage zones overlapping with or adjacent to a coverage zone of another radio site of the set of radio sites; generating, by each radio site of the set of radio sites, an activity bid, wherein the activity bid is selected from the list of bids consisting of: a numerical value between a minimum value and a maximum value, a no activity bid having a numerical value below the minimum value, and a busy bid having a numerical value above the maximum value; selecting, from the set of radio sites, a radio site having a highest activity bid for performing the network service activity; and either: based on at least the selected radio site not having the busy bid, performing the network service activity for the selected radio site; or based on at least the selected radio site having the busy bid, completing the network service activity for the selected radio site.

Alternatively, or in addition to the other examples described herein, examples include any combination of the following:
the wireless network comprises a cellular network;
the radio sites comprise cell sites or cell clusters;
the network service activity comprises an activity selected from the list consisting of: frequency retuning, a software upgrade, maintenance, and a hardware upgrade;
for each radio site of the set of radio sites, except the selected radio site, setting a timer;
upon expiration of the timer, generating new activity bids, and using the new activity bids to select a new radio site from the set of radio sites for performing the network service activity;
a radio site that has already upgraded submits the no activity bid;
a radio site that is currently undergoing the network service activity submits the busy bid;
determining, by each radio site not submitting the no activity bid or the busy bid, the numerical value as inversely related to expected traffic for the radio site for an upgrade period;
based on at least two or more radio sites submitting equal numerical values, selecting from among the two or more radio sites randomly;
selecting the radio site is performed as a peer-to-peer decision, without involving an orchestrator outside the set of radio sites;
prior to performing the network service activity, triggering a handover for each UE being served by the selected radio site and having available coverage from another radio site;
the radio sites comprise cell sites or cell clusters;
the minimum value is 0;
the maximum value is 10;
the no activity bid is −1;
the busy bid is 100;
iterating for each radio site of the set of radio sites, except the selected radio site, setting a timer, generating new activity bids, and using the new activity bids to select a new radio site from the set of radio sites for performing the network service activity until no radio sites require the network service activity is to be performed;
the timer is for one to four hours;
the upgrade period is half of an hour to two hours;
the expected traffic is weighted by traffic type;
traffic for an FWA device is weighted differently than traffic for an eMBB device;
traffic for an eMBB device having WiFi and/or WiFi calling available is weighted differently than traffic for an eMBB device not having WiFi access;
traffic for a UE having a prioritized network slice is weighted differently than traffic for a UE not having a prioritized network slice.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method of performing maintenance on a wireless network, the method comprising:
receiving, by a first radio site of a set of radio sites, an indication that a network service activity is to be performed, wherein the set of radio sites comprises neighbor radio sites each having coverage zones overlapping with or adjacent to a coverage zone of another radio site of the set of radio sites;
generating, by each radio site of the set of radio sites, an activity bid, wherein the activity bid is selected from the list of bids consisting of:
a numerical value between a minimum value and a maximum value, a no activity bid having a numerical value below the minimum value, and a busy bid having a numerical value above the maximum value;
selecting, from the set of radio sites, a radio site having a highest activity bid for performing the network service activity; and
either:
based on at least the selected radio site not having the busy bid, performing the network service activity for the selected radio site; or
based on at least the selected radio site having the busy bid, completing the network service activity for the selected radio site.

2. The method of claim 1, further comprising:
for each radio site of the set of radio sites, except the selected radio site, setting a timer; and
upon expiration of the timer, generating new activity bids, and using the new activity bids to select a new radio site from the set of radio sites for performing the network service activity.

3. The method of claim 1, wherein a radio site that has already upgraded submits the no activity bid, and wherein a radio site that is currently undergoing the network service activity submits the busy bid.

4. The method of claim 1, further comprising:
determining, by each radio site not submitting the no activity bid or the busy bid, the numerical value as inversely related to expected traffic for the radio site for an upgrade period.

5. The method of claim 4, further comprising:
based on at least two or more radio sites submitting equal numerical values, selecting from among the two or more radio sites randomly.

6. The method of claim 1, wherein selecting the radio site is performed as a peer-to-peer decision, without involving an orchestrator outside the set of radio sites.

7. The method of claim 1, wherein the network service activity comprises an activity selected from the list consisting of:
frequency retuning, a software upgrade, maintenance, and a hardware upgrade.

8. The method of claim 1, further comprising:
prior to performing the network service activity, triggering a handover for each user equipment (UE) being served by the selected radio site and having available coverage from another radio site.

9. A system comprising:
a processor; and
a computer-readable medium storing instructions that are operative upon execution by the processor to:
receive, by a first radio site of a set of radio sites, an indication that a network service activity is to be performed, wherein the set of radio sites comprises neighbor radio sites each having coverage zones overlapping with or adjacent to a coverage zone of another radio site of the set of radio sites;
generate, by each radio site of the set of radio sites, an activity bid, wherein the activity bid is selected from the list of bids consisting of:
a numerical value between a minimum value and a maximum value, a no activity bid having a numerical value below the minimum value, and a busy bid having a numerical value above the maximum value;
select, from the set of radio sites, a radio site having a highest activity bid for performing the network service activity; and
either:
based on at least the selected radio site not having the busy bid, perform the network service activity for the selected radio site; or
based on at least the selected radio site having the busy bid, complete the network service activity for the selected radio site.

10. The system of claim 9, wherein the instructions are further operative to:
for each radio site of the set of radio sites, except the selected radio site, set a timer; and
upon expiration of the timer, generate new activity bids, and use the new activity bids to select a new radio site from the set of radio sites for performing the network service activity.

11. The system of claim 9, wherein a radio site that has already upgraded submits the no activity bid, and wherein a radio site that is currently undergoing the network service activity submits the busy bid.

12. The system of claim 9, wherein the instructions are further operative to:
determine, by each radio site not submitting the no activity bid or the busy bid, the numerical value as inversely related to expected traffic for the radio site for an upgrade period.

13. The system of claim 12, wherein the instructions are further operative to:
based on at least two or more radio sites submitting equal numerical values, select from among the two or more radio sites randomly.

14. The system of claim 9, wherein selecting the radio site is performed as a peer-to-peer decision, without involving an orchestrator outside the set of radio sites.

15. One or more computer storage devices having computer-executable instructions stored thereon, which, upon execution by a computer, cause the computer to perform operations comprising:
receiving, by a first radio site of a set of radio sites, an indication that a network service activity is to be performed, wherein the set of radio sites comprises neighbor radio sites each having coverage zones overlapping with or adjacent to a coverage zone of another radio site of the set of radio sites;
generating, by each radio site of the set of radio sites, an activity bid, wherein the activity bid is selected from the list of bids consisting of:
a numerical value between a minimum value and a maximum value, a no activity bid having a numerical value below the minimum value, and a busy bid having a numerical value above the maximum value;
selecting, from the set of radio sites, a radio site having a highest activity bid for performing the network service activity; and
either:
based on at least the selected radio site not having the busy bid, performing the network service activity for the selected radio site; or
based on at least the selected radio site having the busy bid, completing the network service activity for the selected radio site.

16. The one or more computer storage devices of claim 15, wherein the operations further comprise:
for each radio site of the set of radio sites, except the selected radio site, setting a timer; and
upon expiration of the timer, generating new activity bids, and using the new activity bids to select a new radio site from the set of radio sites for performing the network service activity.

17. The one or more computer storage devices of claim 15, wherein a radio site that has already upgraded submits the no activity bid, and wherein a radio site that is currently undergoing the network service activity submits the busy bid.

18. The one or more computer storage devices of claim 15, wherein the operations further comprise:
determining, by each radio site not submitting the no activity bid or the busy bid, the numerical value as inversely related to expected traffic for the radio site for an upgrade period.

19. The one or more computer storage devices of claim 18, wherein the operations further comprise:
based on at least two or more radio sites submitting equal numerical values, selecting from among the two or more radio sites randomly.

20. The one or more computer storage devices of claim 15, wherein selecting the radio site is performed as a peer-to-peer decision, without involving an orchestrator outside the set of radio sites.
